(19) United States
(12) Patent Application Publication
(10) Pub. No.: US 2023/0328160 A1
(43) Pub. Date: Oct. 12, 2023

(54) METHOD, DEVICE, SYSTEM, AND STORAGE MEDIUM FOR MESSAGE PROCESSING

(71) Applicant: ALIBABA GROUP HOLDING LIMITED, George Town (KY)

(72) Inventor: Yilong LYU, Hangzhou (CN)

(21) Appl. No.: 18/320,689

(22) Filed: May 19, 2023

Related U.S. Application Data
(63) Continuation of application No. PCT/CN2021/134251, filed on Nov. 30, 2021.

(30) Foreign Application Priority Data
Dec. 1, 2020 (CN) 202011388416.7

(51) Int. Cl. H04L 69/22

(52) U.S. Cl. CPC H04L 69/22

(57) ABSTRACT

A system includes a central processing unit (CPU) and a programmable device. The programmable device is communicatively coupled to the CPU. The programmable device is configured to provide a message header of an acquired to-be-processed message to the CPU. The CPU is configured to: process the message header to obtain a target message header; and provide the target message header to the programmable device. The programmable device is further configured to splice the target message header with a payload portion of the to-be-processed message to obtain a target message; and forward the target message to a target node referred to in the target message header.

### CROSS-REFERENCE TO RELATED APPLICATIONS

The disclosure claims the benefits of priority to PCT Application No. PCT/CN2021/134251, filed on Nov. 30, 2021, which claims the benefits of priority to Chinese Application 202011388416.7, filed on Dec. 1, 2020, both of which are incorporated herein by reference in their entireties.

### TECHNICAL FIELD

The present disclosure generally relates to communication, and more particularly, to a method, a device, a system, and a storage medium for message processing.

### BACKGROUND

In recent years, as network function virtualization (NFV) applications increase, requirements of user transactions for performance are increasing, and 100G network interface cards are gradually popular. With the continuous improvement of the performance and bandwidth of a network interface card, software forwarding has been unable to meet growing network needs. In order to improve network forwarding performance of a physical machine, a smart Network Interface Card (NIC) comes into being.

By offloading some or all functions of a host to a network interface card and using a Central Processing Unit (CPU) of the NIC for network forwarding, the forwarding performance is low.

### SUMMARY OF THE DISCLOSURE

Embodiments of the present disclosure provide a message processing system. The system includes: a central processing unit (CPU) and a programmable device. The programmable device is communicatively coupled to the CPU. The programmable device is configured to provide a message header of an acquired to-be-processed message to the CPU. The CPU is configured to: process the message header to obtain a target message header; and provide the target message header to the programmable device. The programmable device is further configured to splice the target message header with a payload portion of the to-be-processed message to obtain a target message; and forward the target message to a target node referred to in the target message header.

Embodiments of the present disclosure provide a message processing method, applicable to a programmable device. The method includes acquiring a to-be-processed message; providing a message header of the to-be-processed message to a central processing unit (CPU) communicatively coupled to the programmable device, wherein the CPU processes the message header to obtain a target message header and returns the target message header to the programmable device; splicing the target message header with a payload portion of the to-be-processed message to obtain a target message; and forwarding the target message to a target node referred to in the target message header.

Embodiments of the present disclosure provide a message processing method, applicable to a central processing unit (CPU). The method includes acquiring a message header of a to-be-processed message provided by a programmable device communicatively coupled to the CPU; processing the message header to obtain a target message header; and providing the target message header to the programmable device, wherein the programmable device is configured to splice the target message header with a payload portion of the to-be-processed message to obtain a target message and forward the target message.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1A is a schematic structural diagram of an example message processing system, according to some embodiments of the present disclosure.

FIG. 1B is a structural schematic diagram of an example network interface card, according to some embodiments of the present disclosure.

FIG. 1C and FIG. 1D are schematic diagrams illustrating an example message processing process, according to some embodiments of the present disclosure.

FIG. 1E is a schematic diagram illustrating an example process for processing, by a network interface card, a message sent by a host, according to some embodiments of the present disclosure.

FIG. 1F is a schematic diagram illustrating an example process for processing, by a network interface card, a message received by a host, according to some embodiments of the present disclosure.

FIG. 2A is a schematic structural diagram of an example network device, according to some embodiments of the present disclosure.

FIG. 2B is a schematic structural diagram of an example computer device, according to some embodiments of the present disclosure.

FIG. 2C is a schematic structural diagram of another example network device, according to some embodiments of the present disclosure.

FIG. 3 is a flow chart illustrating an example message processing method, according to some embodiments of the present disclosure.

FIG. 4 is a flow chart illustrating another example message processing method, according to some embodiments of the present disclosure.

FIG. 5 is a schematic structural diagram of an example data processing system, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

To resolve a technical problem of relatively low network forwarding performance of the existing hardware offload scheme, in some embodiments of the present disclosure, a message header of a to-be-processed message is provided by a programmable device to a CPU for processing, and the message header processed by the CPU and a payload portion of the to-be-processed message are spliced to obtain a target message. Therefore, the payload portion of the message is processed using high performance of hardware of the programmable device, and the message header can be processed using flexibility of software in the CPU to process a complicated transaction logic. Since the message header is relatively short, performance loss in CPU software processing due to long-message copy processing does not occur, thus facilitating improvement of the network forwarding performance.

The technical solutions disclosed by the embodiments of the present disclosure are described in detail below in conjunction with the accompanying drawings.

It should be noted that identical reference signs indicate identical objects in the following drawings and embodiments. Therefore, once a certain object is defined in one drawing or embodiment, it is unnecessary to further define and explain it in the subsequent drawings and embodiments.

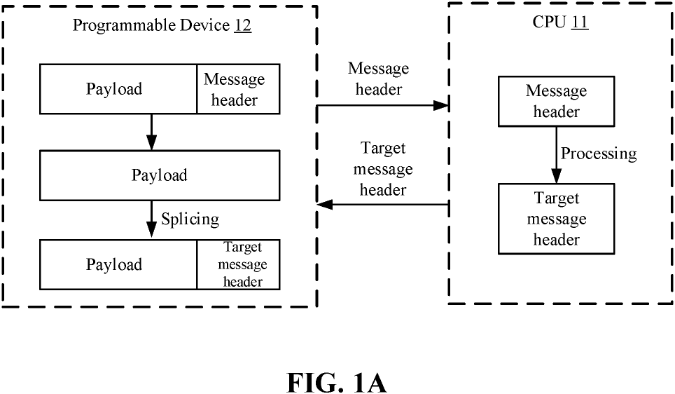

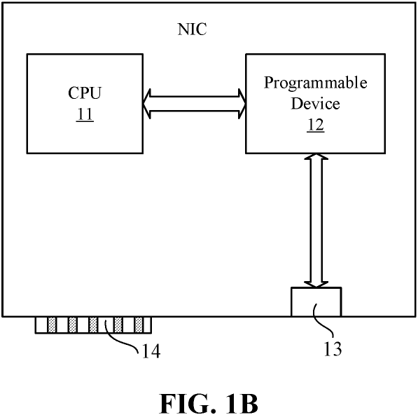

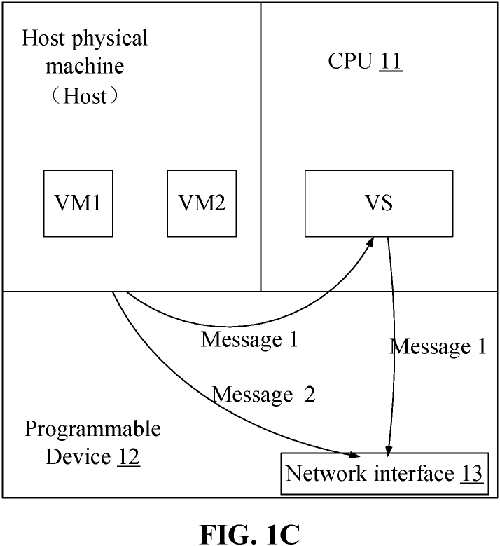

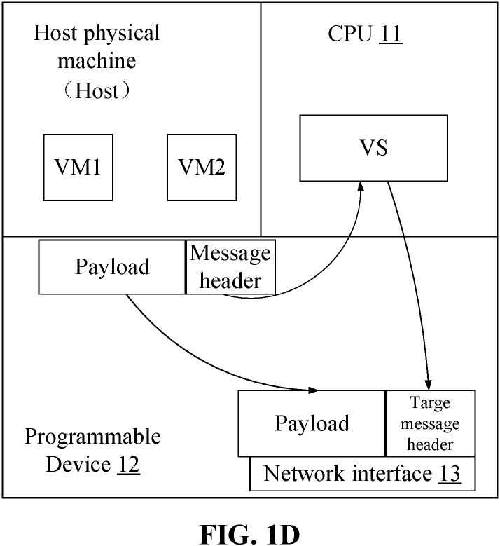

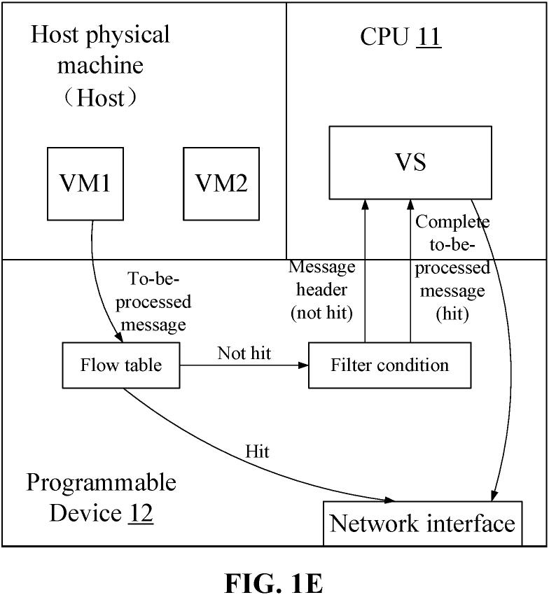

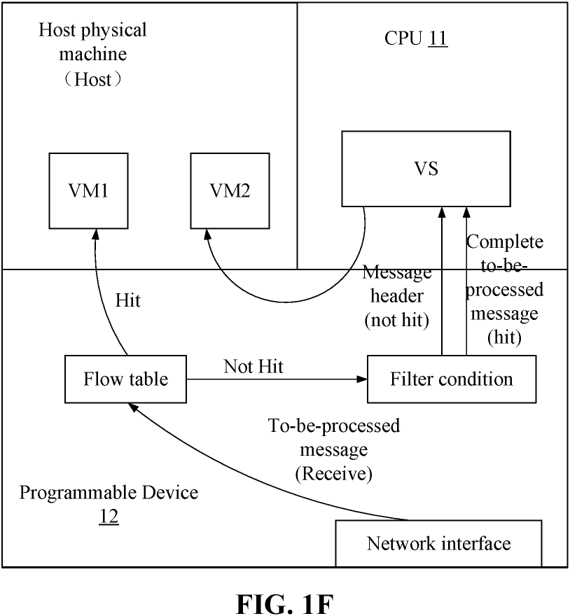

FIG. 1A is an example schematic structural diagram of a message processing system, according to some embodiments of the present disclosure; As shown in FIG. 1A, the message processing system includes a CPU 11 and a programmable device 12. CPU 11 and programmable device 12 are communicatively coupled. In some embodiments, CPU 11 and programmable device 12 can be communicatively coupled by a data bus. The data bus can be a serial interface data bus, such as a PCIe serial interface, a USB serial interface, an RS485 interface or an RS232 interface, which is not limited herein.

In this example, CPU 11 may be an independent chip, a CPU integrated in a System on Chip (SoC), a CPU integrated in a Microcontroller Unit (MCU), or the like.

Programmable device 12 refers to a hardware processing unit that uses a hardware description language (HDL) for data processing. The HDL may be VHDL, Verilog HDL, System Verilog, System C, or the like. Programmable device 12 may be a Field-Programmable Gate Array (FPGA), a Programmable Array Logic (PAL), a General Array Logic (GAL), a Complex Programmable Logic Device (CPLD), etc. Alternatively, the programmable device may also be an Application Specific Integrated Circuit (ASIC).

In some embodiments, CPU 11 and programmable device 12 may be deployed in the same network device or in different network devices. For example, CPU 11 and programmable device 12 may be deployed in a Network Interface Card (NIC) (as shown in FIG. 1B), or CPU 11 and programmable device 12 may also be deployed in a gateway or a router.

When CPU 11 and programmable device 12 are deployed in different network devices, programmable device 12 may be deployed in the NIC, and CPU 11 may be deployed in a host. The NIC may be installed on the host. In some embodiments, as shown in FIG. 1B, the NIC may be provided with bus interface 14, and is installed on the host through bus interface 14. Bus interface 14 may be a serial bus interface, such as a PCIe serial interface, a USB serial interface, an RS485 interface or an RS232 interface, which is not limited herein. In some embodiments, as shown in FIG. 1C, a first packet (such as message 1) of network forwarding traffic does not have a forwarded flow table for processing this data stream in programmable device 12. A flow table refers to an abstraction of a data forwarding function of a network device. Entries in a flow table integrate network configuration information at all layers of a network, so that richer rules can be used during data forwarding. Each flow entry of a flow table includes three parts: Header Fields for data packet matching, Counters for counting the number of matched data packets, and Actions for showing how to process the matched data packets. Therefore, message 1 will be sent to CPU 11 for processing. CPU 11 processes message 1, generates a flow table for processing message 1, and sends the flow table to programmable device 12. In this way, subsequent messages (such as message 2) can hit the forwarding flow table on programmable device 12. Message 2 can be processed by programmable device 12 and forwarded by programmable device 12. For an NIC, message 2 can be forwarded by programmable device 12 in the NIC to network interface 13 of the NIC.

In this example, a communication component in network interface 13 is configured to facilitate wired or wireless communication between a device where communication component is located and other devices. The device where the communication component is located may access a wireless network based on a communication standard, such as WiFi, 2G or 3G, 4G or 5G, or a combination thereof. In one exemplary example, the communication component receives a broadcast signal or broadcast related information from an external broadcast management system via a broadcast channel. In one exemplary example, the communication component can also be implemented based on a near-field communication (NFC) technology, a radio frequency identification (RFID) technology, an infrared data association (IrDA) technology, an ultra-wideband (UWB) technology, a Bluetooth (BT) technology or other technologies.

In the above implementation, CPU 11 processes a first packet of a data stream. The software processing flexibility is high, but the processing performance is poor. Especially when a long message is processed, the software processing performance is seriously affected due to a need for multiple copies of an internal memory of the CPU. On the other hand, programmable device 12 processes subsequent messages of the data stream, which can achieve hardware acceleration. However, this scheme also brings a limitation to the flexibility. Since hardware cannot be modified as often as software, and a development iteration cycle of hardware is much longer than that of software, it is difficult to meet a rapid iteration requirement of a cloud network. In addition, due to resource limitation, it is difficult for hardware to meet a continuous increase of functions of the cloud network.

In order to solve the above problems and take into account the flexibility and high performance of message processing, embodiments of the present disclosure provide a message processing manner combining software and hardware, that is, a network hardware offload scheme. A specific implementation process is as follows:

As shown in FIG. 1A and FIG. 1D, for a to-be-processed message, programmable device 12 may provide a message header of the to-be-processed message to CPU 11. In some embodiments, programmable device 12 may provide the message header of the to-be-processed message to CPU 11 when the flow table for processing the to-be-processed message does not exist locally. In this example, local refers to a storage unit of programmable device 12.

The to-be-processed message refers to a message acquired by programmable device 12. This message may be a message sent by a network device where programmable device 12 is located to other physical machines, or a message sent by other physical machines and received by a network device where programmable device 12 is located.

In this example, processing a message mainly refers to forwarding a message. In a message forwarding process, the message header needs to be processed according to actual needs. The processing of the message header may include one or multiple of modifying a source address and a destination address in the message header; performing safety verification by using information in the message header; and looking up a routing table by using the information in the message header, which is not limited herein. The multiple means two or more.

CPU 11 may receive the message header provided by programmable device 12. In this example, CPU 11 may process the message header to obtain a target message header. In some embodiments, a Virtual Switch (VS) may run in CPU 11. The VS running in CPU 11 processes the message header to obtain the target message header. Further, CPU 11 may provide the target message header to programmable device 12. CPU 11 may process the message header according to actual needs. A processing manner may refer to the above description.

Correspondingly, programmable device 12 may receive the target message header and splice the target message header with a payload portion of the to-be-processed message to obtain a target message. Further, programmable device 12 may forward the target message to a target node referred to in the target message header.

As shown in FIG. 1E, programmable device 12 may be a programmable device in the NIC. If the to-be-processed message is a message sent, to other physical machines, by a host where a smart NIC is located, programmable device 12 may send the target message to network interface 13 and forward the target message to other physical machines through network interface 13. In this implementation, the target node is another physical machine.

As shown in FIG. 1F, programmable device 12 may be a programmable device in the NIC. If the to-be-processed message is a message sent by other physical machines and received by the host where the smart NIC is located, that is, if the to-be-processed message is a message sent by other physical machines to the host where the smart NIC is located and received by network interface 13, programmable device 12 may send the target message to a virtual machine (VM) running in the host.

In the message processing system provided by this example, a programmable device can provide a message header of a to-be-processed message for a CPU for processing, and splice the message header processed by the CPU with a payload portion of the to-be-processed message to obtain a target message, so that the payload portion of the message is processed using high performance of hardware of the programmable device, and the message header can be processed using flexibility of software in the CPU to process a complicated transaction logic. Since the message header is relatively short, for example, 256 bytes, performance loss in CPU software processing due to long-message copy processing does not occur, thus facilitating improvement of network forwarding performance. For example, since the message header is processed by the software VS in the CPU only in this example, a network forwarding performance may be tens of millions of pps and have a bandwidth of 100G. pps refers to a quantity of messages forwarded per second.

On the other hand, the CPU processes the message header. Since software has a relatively short development cycle, it helps to meet a requirement for message forwarding flexibility and can meet the rapid iteration requirement of the cloud network.

In the embodiments of the present disclosure, CPU 11 may also generate, after or during the processing of the header of the to-be-processed message, a flow table for processing the header of the to-be-processed message. In some embodiments, CPU 11 may invoke an ovs_flow_cmd_new function that creates a flow table, to generate the flow table for processing the header of the to-be-processed message. The structure of the flow table can be seen in the relevant description of the above example, and will not be repeated here. Further, CPU 11 may provide the flow table for processing the message header of the to-be-processed message for programmable device 12.

Correspondingly, programmable device 12 may receive the flow table for processing the message header of the to-be-processed message and store the flow table locally. In this way, when subsequently receiving other messages belonging to the same data stream as the to-be-processed message, programmable device 12 may directly process other messages, thereby realizing hardware offload of message forwarding, and improving the network forwarding performance.

A message belonging to the same data stream as the to-be-processed message refers to a message with the same data stream identifier as that of the to-be-processed message. the data stream identifier may be five-tuple information of the message header. Five-tuple include: a source IP address, a source port, a destination IP address, a destination port, and a transport layer protocol.

Based on this, as shown in FIG. 1E and FIG. 1F, programmable device 12 may acquire the data stream identifier in the message header of the to-be-processed message when determining whether a flow table for processing the to-be-processed message exists locally; match the data stream identifier with locally stored flow tables. If the data stream identifier in the message header of the to-be-processed message does not exist in the locally stored flow tables, programmable device 12 may determine that no flow table for processing the to-be-processed message exists locally; if the locally stored flow tables include a flow table that matches the data stream identifier in the message header of the to-be-processed message, programmable device 12 may take the matched flow table as a target flow table, and process the to-be-processed message according to a processing manner recorded by a flow entry of the target flow table, so as to obtain a target message. Further, programmable device 12 may forward the to-be-processed message to a target node referred to in the target message header.

In some embodiments, as shown in FIG. 1E and FIG. 1F, programmable device 12 also stores a filter condition at which the complete message needs to be provided to CPU 11 for processing. The filter condition may include: the data stream identifier of the message that needs to be completely provided to CPU 11, one or more of the five-tuple, a destination network address, and a source network address. In some embodiments, the destination network address may be represented by a destination IP address and a subnet mask, and the source network address may be represented by a source IP address and a subnet mask. For example, if the source network address may be expressed as XXX.XXX.0.0/16, and correspondingly, if previous 16 bits of the source IP address of the to-be-processed message are the same as previous 16 bits of the source IP address in the filter condition, it is determined that the complete to-be-processed message needs to be provided to CPU 11.

Correspondingly, when the flow table for processing the to-be-processed message does not exist locally, programmable device 12 may determine, on the basis of the data stream identifier in the message header of the to-be-processed message and the filter condition, whether to provide the complete to-be-processed message to CPU 11. In some embodiments, if the filter condition includes a destination network address and a source network address, programmable device 12 may parse the message header of the to-be-processed message to obtain the destination IP address and source IP address; acquire the destination network address and source network address of the to-be-processed message from the destination IP address and source IP address; match the destination network address and source network address of the to-be-processed message with the destination network address and source network address in the filter conditions; and if matching succeeds, determine that the complete to-be-processed message needs to be provided to CPU 11. Further, programmable device 12 may provide the complete to-be-processed message to CPU 11 for processing.

Correspondingly, if a determination result is that the complete to-be-processed message does not need to be provided to CPU 11, programmable device 12 may provide the message header of the to-be-processed message to CPU 11, and CPU 11 processes the message header of the to-be-processed message.

In some embodiments of the present disclosure, different message processing manners can be used for messages with different transaction information. For example, according to requirements of different transaction information on a message processing rate, a message processing manner that meets the requirement on the message processing rate can be used for processing. The transaction information may include a transaction user and a transaction type. In some embodiments, the message processing manners include at least two of the above manners: processing by CPU 11 and programmable device 12, processing by programmable device 12 only, and processing by CPU 11 only.

Correspondingly, programmable device 12 may acquire transaction information of the to-be-processed message. In some embodiments, the transaction information of the to-be-processed message may be extracted from information of the to-be-processed message header. Further, a processing manner of the to-be-processed message may be determined according to the transaction information of the to-be-processed message. If the to-be-processed message is processed by CPU 11 and programmable device 12, programmable device 12 may provide the message header of the to-be-processed message to CPU 11. For the specific implementation in which CPU 11 processes the message header to obtain a target message header, and programmable device 12 splices the target message header with a payload portion of the to-be-processed message, a reference will be made to the relevant description of the above embodiments, which will not be repeated here.

In practical applications, the transaction information of a message includes a transaction type to which the message belongs, and information of a user sending or receiving the message. Transaction types required by a message may include, but are not limited to, a video transaction, an email transaction, a Web transaction, an instant messaging transaction, and the like. Different transactions have different requirements for bandwidths, jitter, delays, and the like, so they have different processing rates on the to-be-processed message. Based on this, the transaction type of the to-be-processed message may be acquired from the transaction information of the to-be-processed message; and a target service grade corresponding to the transaction type of the to-be-processed message may be determined. A service grade can be determined according to a requirement of the transaction type on the message processing rate. The transaction types that require the same or similar message processing rate belong to the same service grade. Further, a corresponding relationship between a transaction type and a service grade can be preset. Correspondingly, the transaction type of the to-be-processed message may be matched in the corresponding relationship between the transaction type and the service grade, so as to determine the target service grade corresponding to the transaction type of the to-be-processed message.

Further, programmable device 12 may acquire a message processing manner corresponding to the target service grade as a processing manner of the to-be-processed message. In some embodiments, a corresponding relationship between a service grade and a message processing manner may be preset. Correspondingly, the target service grade may be matched in the corresponding relationship between the service grade and the message processing manner, so as to determine the message processing manner corresponding to the target service grade.

In other examples, different message forwarding rates may be provided for different users. For example, higher message processing efficiency is provided for users with a higher network cost. Lower message processing efficiency is provided for users with a lower network cost. Based on this, programmable device 12 may acquire a transaction user identifier from the transaction information of the to-be-processed message. In some embodiments, the transaction user identifier may be address information of a user terminal. The address information of the user terminal may include a media access control (MAC) address and/or an intellectual property (IP) address of the terminal.

Further, programmable device 12 may acquire a message processing manner corresponding to the transaction user identifier as a processing manner of the to-be-processed message. In some embodiments, a corresponding relationship between a user identifier and a message processing manner may be preset. Correspondingly, the transaction user identifier of the to-be-processed message may be matched in the corresponding relationship between the transaction user identifier and the message processing manner, so as to determine a target service grade corresponding to the transaction type of the to-be-processed message.

In other examples, it is necessary to simultaneously classify transaction types and users to classify the message processing manners, and programmable device 12 may use a combination of the above two manners to determine the processing manner of the to-be-processed message.

It is worth noting that the above message processing system provided by the embodiments of the present disclosure can be deployed in the same network device or in different network devices. When the above CPU and programmable device are deployed in the same network device, the network device can be an NIC, a gateway or a router. The following is an exemplary description of the network device provided by the embodiments of the present disclosure.

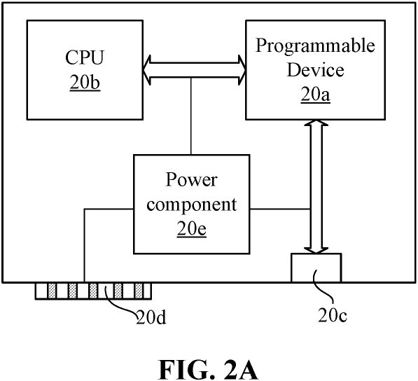

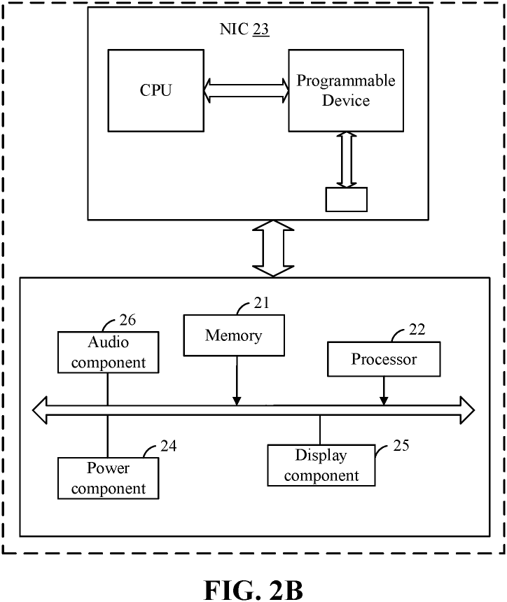

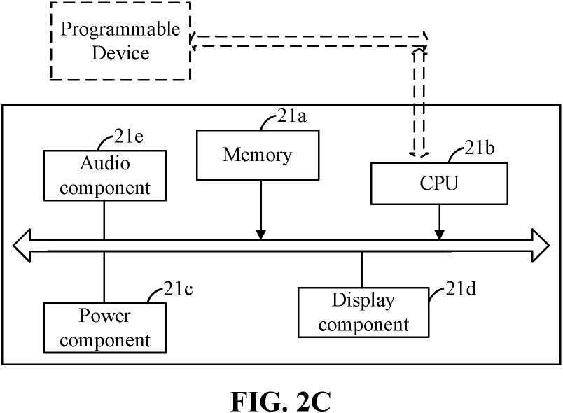

FIG. 2A is an example schematic structural diagram of a network device, according to some embodiments of the present disclosure. As shown in FIG. 2A, the network device provided by this example of the present disclosure includes a programmable device 20a. Programmable device 20a may be communicatively coupled to a CPU. A connection manner may be seen in the relevant contents of the above system embodiments, which will not be repeated here. In some embodiments, the network device may also include a CPU 20b. Programmable device 20a may be communicatively coupled to CPU 20b. Of course, programmable device 20a may also be in communication with CPUs in other physical machines. For example, if the network device is an NIC, programmable device 20a in the NIC may be also communicatively coupled to a CPU of a host of the NIC.

In this example, in order to take into account the flexibility and high performance of message processing, embodiments of the present disclosure provide a message processing manner combining software and hardware, that is, a network hardware offload scheme. A specific implementation process is as follows:

For a to-be-processed message, programmable device 20a may provide a message header of the to-be-processed message to the CPU communicatively coupled to programmable device 20a. In some embodiments, programmable device 20a may provide, when the flow table for processing the to-be-processed message does not exist locally, the message header of the to-be-processed message to the CPU communicatively coupled to programmable device 20a. In this example, local refers to a storage unit of programmable device 20a.

The to-be-processed message refers to a message received by programmable device 20a. This message may be a message sent by the network device to other physical machines, or a message sent by other physical machines and received by the network device.

The CPU communicatively coupled to programmable device 20a may receive the message header provided by the programmable device. In this example, the CPU may process the message header to obtain a target message header. In some embodiments, a VS may run in the CPU. The VS running in the CPU processes the message header to obtain the target message header. Further, CPU may provide the target message header to programmable device 20a. Correspondingly, programmable device 20a may receive the target message header and splice the target message header with a payload portion of the to-be-processed message to obtain a target message. Further, programmable device 20a may forward the target message to a target node referred to in the target message header.

If the to-be-processed message is a message sent by the network device to other physical machines, the programmable device may send the target message to network interface 20c and forward the target message to other physical machines through network interface 20c. In this example, the target node is another physical machine.

If the message to be processed is a message sent by other physical machines received by the network equipment, that is, the message to be processed is a message sent to the network equipment by other physical machines received by the network interface 20c, then the programmable device can send the target message to a virtual machine (VM) running on the network device.

In the network device provided by this example, the programmable device of the network device can provide the message header of the to-be-processed message to the CPU communicatively coupled to the programmable device for processing, and splice the message header processed by the CPU with the payload portion of the to-be-processed message to obtain the target message, so that the payload portion of the message is processed using high performance of hardware of the programmable device, and the message header can be processed using flexibility of software in the CPU to process a complicated transaction logic. Since the message header is relatively short, for example, 256 bytes, performance loss in CPU software processing due to long-message copy processing does not occur, thus facilitating improvement of network forwarding performance.

On the other hand, the CPU processes the message headers. Due to the short software development cycle, it helps to meet the requirements for the flexibility of message forwarding and the rapid iteration requirements of the cloud network.

In the embodiments of the present disclosure, the CPU may also generate, after or during the processing of the header of the to-be-processed message, a flow table for processing the header of the to-be-processed message. Further, the CPU may provide the flow table for processing the message header of the to-be-processed message for the programmable device.

Correspondingly, programmable device 20a may receive the flow table for processing the message header of the to-be-processed message and store the flow table locally. In this way, when subsequently receiving other messages belonging to the same data stream as the to-be-processed message, the programmable device may directly process other messages, thereby realizing hardware offload of message forwarding, and improving the network forwarding performance.

A message belonging to the same data stream as the to-be-processed message refers to a message with the same data stream identifier as that of the to-be-processed message. the data stream identifier may be five-tuple information of the message header. Five-tuple includes: a source IP address, a source port, a destination IP address, a destination port and a transport layer protocol.

Based on this, programmable device 20a is configured to acquire the data stream identifier in the message header of the to-be-processed message when determining whether a flow table for processing the to-be-processed message exists locally; and match the data stream identifier with locally stored flow tables. If the data stream identifier in the message header of the to-be-processed message does not exist in the locally stored flow tables, it is determined that no flow table for processing the to-be-processed message exists locally. If the locally stored flow tables include a flow table that matches the data stream identifier in the message header of the to-be-processed message, the matched flow table is taken as a target flow table; and the to-be-processed message is processed according to a processing manner recorded by a flow entry of the target flow table, so as to obtain a target message. Further, the programmable device may forward the to-be-processed message to a target node referred to in the target message header.

In some embodiments, programmable device 20a also stores a filter condition at which the complete message needs to be provided to the CPU for processing. The filter condition may include: a data stream identifier of the message that needs to be completely provided to the CPU, one or more of the five tuples, a destination network address and a source network address.

Correspondingly, when the no flow table for processing the to-be-processed message does not exist locally, programmable device 20a is configured to determine, on the basis of the data stream identifier in the message header of the to-be-processed message and the filter condition, whether to provide the complete to-be-processed message to the CPU. In some embodiments, if the filter condition include a destination network address and a source network address, the programmable device may parse the message header of the to-be-processed message to obtain the destination IP address and source IP address; acquire the destination network address and source network address of the to-be-processed message from the destination IP address and source IP address; and match the destination network address and source network address of the to-be-processed message with the destination network address and source network address in the filter conditions. If matching succeeds, it is determined that the complete to-be-processed message needs to be provided to the CPU. Further, programmable device 20a may provide the complete to-be-processed message to the CPU for processing.

Correspondingly, if a determination result is that the complete to-be-processed message does not need to be provided to the CPU, programmable device 20a may provide the message header of the to-be-processed message to the CPU, and the CPU processes the message header of the to-be-processed message.

In some embodiments, the network device further include network interface 20c. Network interface 20c is used for forwarding messages.

In some embodiments, the network device may be implemented as an NIC. The NIC may also include network interface 20c and bus interface 20d. The NIC may be mounted on a host through bus interface 20d. Network interface 20c is used for receiving messages sent by other physical machines to the host and forwarding messages sent by the host.

In some embodiments, programmable device 20a is also configured to acquire transaction information of the to-be-processed message; and determine a processing manner of the to-be-processed message according to the transaction information of the to-be-processed message. If the processing manner of the to-be-processed message is implemented by a CPU and a programmable device, the message header of the to-be-processed message is provided to the CPU.

In some embodiments, during determining a processing manner of the to-be-processed message, programmable device 20a is specifically configured to: acquire a transaction type of the to-be-processed message from the transaction information of the to-be-processed message; determine a target service grade corresponding to the transaction type of the to-be-processed message; acquire a message processing manner corresponding to the target service grade as the processing manner of the to-be-processed message; and/or acquire a transaction user identifier from the transaction information of the to-be-processed message; and acquire a message processing manner corresponding to the transaction user identifier as the processing manner of the to-be-processed message.

In some embodiments, as shown in FIG. 2A, the network device may also include a power component 20e and other optional components. FIG. 2A only shows some components schematically, which neither means that the network device has to include all the components shown in FIG. 2A, nor means that the network device can only include the components shown in FIG. 2A.

The network device provided in FIG. 2A can be implemented as an NIC. Correspondingly, some embodiments of the present disclosure further provide a computer device with the above NIC. The computer device may be a desktop, a laptop, a smart phone, a tablet, a wearable device and other terminal devices, or a server, a server array and other server devices. The following is an exemplary description of the computer device provided by some embodiments of the present disclosure.

FIG. 2B is a schematic structural diagram of an example computer device, according to some embodiments of the present disclosure. As shown in FIG. 2B, the computer device includes a memory 21 and a processing unit 22, and is provided with a NIC 23 described above. In this example, NIC 23 may be mounted on the computer device by means of a bus interface. An implementation form of the bus interface can be seen in the relevant contents of the above embodiment, and will not be repeated here.

In this example, NIC 23 includes a CPU and a programmable device. The CPU and the programmable device are communicatively coupled.

In order to take into account the flexibility and high performance of message processing, embodiments of the present disclosure provide a message processing manner combining software and hardware, that is, a network hardware offload scheme. A specific implementation process is as follows:

For a to-be-processed message, the programmable device may provide a message header of the to-be-processed message to the CPU. In some embodiments, the programmable device may provide the message header of the to-be-processed message to the CPU when the flow table for processing the to-be-processed message does not exist locally. In this example, local refers to a storage unit of the programmable device.

The to-be-processed message refers to a message received by the programmable device. This message may be a message sent by the computer device to other physical machines, or a message sent by other physical machines and received by the computer device where the NIC is located.

The CPU of the NIC may receive the message header provided by the programmable device. In this example, the CPU may process the message header to obtain a target message header. In some embodiments, a VS may run in the CPU of the NIC. The VS running in the CPU processes the message header to obtain the target message header. Further, the CPU may provide the target message header to the programmable device. Correspondingly, the programmable device may receive the target message header and splice the target message header with a payload portion of the to-be-processed message to obtain a target message. Further, the programmable device may forward the target message to a target node referred to in the target message header.

If the to-be-processed message is a message sent, to other physical machines, by a host where the NIC is located, the programmable device may send the target message to a network interface and forward the target message to other physical machines through the network interface. In this implementation, the target node is another physical machine.

If the to-be-processed message is a message sent by other physical machines and received by the host where the NIC is located, that is, if the to-be-processed message is a message sent by other physical machines to the host where the NIC is located and received by the network interface, the programmable device may send the target message to a VM running in the host.

In the computer device provided by this example, when the flow table for processing the to-be-processed message does not exist locally, the programmable device in the NIC of the computer device can provide, the message header of the to-be-processed message to the CPU of the NIC for processing, and splice the message header processed by the CPU with a payload portion of the to-be-processed message to obtain the target message, so that the payload portion of the message is processed using high performance of hardware of the programmable device, and the message header can be processed using flexibility of software in the CPU to process a complicated transaction logic. Since the message header is relatively short, for example, 256 bytes, performance loss in CPU software processing due to long-message copy processing does not occur, thus facilitating improvement of network forwarding performance.

On the other hand, the CPU of the NIC processes the message header. Since software has a relatively short development cycle, it helps to meet a requirement for message forwarding flexibility and can meet the rapid iteration requirement of the cloud network.

In this example of the present disclosure, the CPU of the NIC may also generate, after or during the processing of the header of the to-be-processed message, a flow table for processing the header of the to-be-processed message. Further, the CPU may provide the flow table for processing the message header of the to-be-processed message to the programmable device.

Correspondingly, the programmable device may receive the flow table for processing the message header of the to-be-processed message and store the flow table locally. In this way, when subsequently receiving other messages belonging to the same data stream as the to-be-processed message, the programmable device may directly process other messages, thereby realizing hardware offload of message forwarding, and improving the network forwarding performance.

A message belonging to the same data stream as the to-be-processed message refers to a message with the same data stream identifier as that of the to-be-processed message. the data stream identifier may be five-tuple information of the message header. Five-tuple includes: a source IP address, a source port, a destination IP address, a destination port and a transport layer protocol.

Based on this, the programmable device is configured to acquire the data stream identifier in the message header of the to-be-processed message when determining whether a flow table for processing the to-be-processed message exists locally; and match the data stream identifier with locally stored flow tables. If the data stream identifier in the message header of the to-be-processed message does not exist in the locally stored flow tables, it is determined that no flow table for processing the to-be-processed message exists locally. If the locally stored flow tables include a flow table that matches the data stream identifier in the message header of the to-be-processed message, the matching flow table is taken as a target flow table; and the to-be-processed message is processed according to a processing manner recorded by a flow entry of the target flow table, so as to obtain a target message. Further, the programmable device may forward the to-be-processed message to a target node referred to in the target message header.

In some embodiments, the programmable device also stores a filter condition at which the complete message needs to be provided to the CPU of the NIC for processing. The filter condition may include at least one of: a data stream identifier of the message that needs to be completely provided to the CPU of the NIC, one or more of the five tuples, a destination network address and a source network address.

Correspondingly, when the flow table for processing the to-be-processed message does not exist locally, the programmable device may determine, on the basis of the data stream identifier in the message header of the to-be-processed message and the filter condition, whether to provide the complete to-be-processed message to the CPU. In some embodiments, if the filter condition include: a destination network address and a source network address, the programmable device may parse the message header of the to-be-processed message to obtain the destination IP address and source IP address; acquire the destination network address and source network address of the to-be-processed message from the destination IP address and source IP address; and match the destination network address and source network address of the to-be-processed message with the destination network address and source network address in the filter conditions. If matching succeeds, it is determined that the complete to-be-processed message needs to be provided to the CPU. Further, the programmable device may provide the complete to-be-processed message to the CPU for processing.

Correspondingly, if a determination result is that the complete to-be-processed message does not need to be provided to the CPU, the programmable device may provide the message header of the to-be-processed message to the CPU, and the CPU processes the message header of the to-be-processed message.

In some embodiments, the programmable device is also configured to acquire transaction information of the to-be-processed message; and determine a processing manner of the to-be-processed message according to the transaction information of the to-be-processed message. If the processing manner of the to-be-processed message is implemented by a CPU and a programmable device, the message header of the to-be-processed message is provided to the CPU.

In some embodiments, during determining a processing manner of the to-be-processed message, the programmable device is specifically configured to: acquire a transaction type of the to-be-processed message from the transaction information of the to-be-processed message; determine a target service grade corresponding to the transaction type of the to-be-processed message; acquire a message processing manner corresponding to the target service grade as the processing manner of the to-be-processed message; and/or acquire a transaction user identifier from the transaction information of the to-be-processed message; and acquire a message processing manner corresponding to the transaction user identifier as the processing manner of the to-be-processed message.

In some embodiments, as shown in FIG. 2B, the computer device may also include a power component 24, a display component 25, an audio component 26 and other optional components. FIG. 2B only shows some components schematically, which neither means that the computer device has to include all the components shown in FIG. 2B, nor means that the computer device can only include the components shown in FIG. 2B.

In addition to the computer device with the NIC including the CPU and the programmable device, some embodiments of the present disclosure further provide a network device. As shown in FIG. 2C, the network device includes a memory 21a and a CPU 21b. CPU 21b and the programmable device are communicatively coupled. Memory 21a is configured to store a computer program.

CPU 21b is coupled to memory 21a, and is configured to execute the computer program to: acquire a message header of a to-be-processed message provided by the programmable device communicatively coupled to CPU 21b; process the message header to obtain a target message header; and provide the target message header to the programmable device, so that the programmable device splices the target message header with a payload portion of the to-be-processed message to obtain a target message, and forwards the target message.

In some embodiments, CPU 21b is also configured to generate a flow table for processing the message header; and provide the flow table for processing the message header to the programmable device, so that the programmable device processes, on the basis of the flow table for processing the message header, other messages matching a data stream identifier of the to-be-processed message.

In some embodiments, the programmable device may be deployed in an NIC. The NIC may be mounted in the network device provided in this example. In some embodiments, the NIC may be mounted in the network device provided in this example by means of a bus interface.

In some embodiments, as shown in FIG. 2C, the computer device may also include a power component 21c, a display component 21d, an audio component 21e and other optional components. FIG. 2C only shows some components schematically, which neither means that the network device has to include all the components shown in FIG. 2C, nor means that the network device can only include the components shown in FIG. 2C.

The network device provided by this example includes a CPU. The CPU may be communicatively coupled to the programmable device to process the message header. Since software has a relatively short development cycle, it helps to meet a requirement for message forwarding flexibility and can meet the rapid iteration requirement of the cloud network.

In the embodiments of the present disclosure, the memory is configured to store a computer program, and may be configured to store various other data to support operations on the device where the memory is located. The processing unit may execute the computer program stored in the memory to implement corresponding control logic. The memory may be implemented by any type of volatile or non-volatile storage devices or a combination thereof, such as Static Random Access Memory (SRAM), an Electrically Erasable Programmable Read-Only Memory (EEPROM), a Programming Read-Only Memory (EPROM), a Programmable Read-Only Memory (PROM), a Read-Only Memory (ROM), a magnetic memory, a flash memory, a magnetic disk or an optical disk.

In the embodiments of the present disclosure, the processing unit may be any hardware processing device that can execute the above method logic. In some embodiments, the processing unit can be, but is not limited to, a Central Processing Unit (CPU), a Graphics Processing Unit (GPU), a Microcontroller Unit (MCU), a programmable device, such as a Field-Programmable Gate Array (FPGA), a Programmable Array Logic (PAL), a General Array Logic (GAL) and a Complex Programmable Logic Device (CPLD), Advanced RISC Machines (ARM) or a System on Chip (SOC), or the like.

In the embodiments of the present disclosure, the display component may include a Liquid Crystal Display (LCD) and a Touch Panel (TP). If it includes the TP, the display component may be implemented as a touch screen, to receive an input signal from a user. The TP includes one or more touch sensors to sense touch, swipe, and gestures on the TP. The touch sensor may not only sense a boundary of a touch or swipe action, but also detect duration and pressure related to the touch or swipe operation.

In the embodiment of the present disclosure, the power component is configured to supply power to the various components of the device. The power component may include a power management system, one or more power supplies, and other components associated with generation, management, and distribution of power for the device including the power component.

In the embodiment of the present disclosure, the audio component is configured to output and/or input audio signals. For example, the audio component includes a microphone (MIC), and the microphone is configured to receive an external audio signal when the electronic device is in an operation mode, such as a calling mode, a recording mode, and a voice identification mode. The received audio signal may be further stored in the memory or transmitted via the communication component. In some embodiments, the audio component further includes a speaker configured to output audio signals. For example, for devices with a language interaction function, voice interaction with users can be realized through the audio component.

In addition to the above message processing system and devices, some embodiments of the present disclosure further provides a message processing method. The following is an exemplary example of the message processing method according to some embodiments of the present disclosure in view of the programmable devices and CPUs.

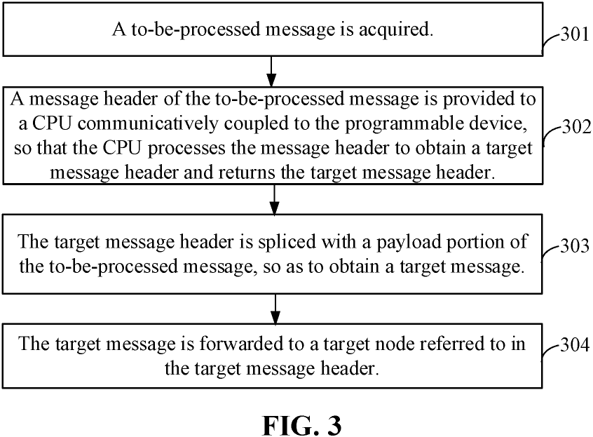

FIG. 3 is a flow diagram of an example message processing method, according to some embodiments of the present disclosure. The method is applicable to a programmable device in an NIC. As shown in FIG. 3, the method includes steps 301 to 304.

At step 301, a to-be-processed message is acquired.

At step 302, a message header of the to-be-processed message is provided to a CPU communicatively coupled to the programmable device, so that the CPU processes the message header to obtain a target message header and returns the target message header.

At step 303, the target message header is spliced with a payload portion of the to-be-processed message, so as to obtain a target message.

At step 304, the target message is forwarded to a target node referred to in the target message header.

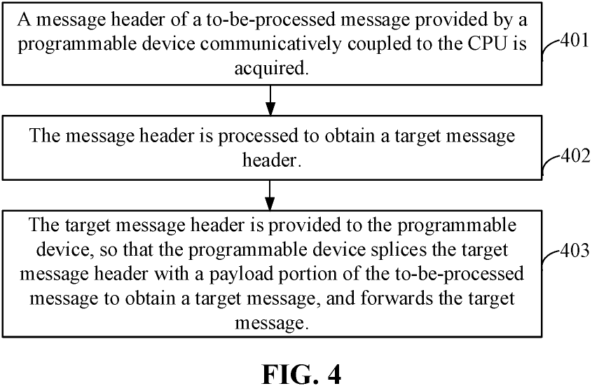

FIG. 4 is a flow diagram of another example message processing method, according to some embodiments of the present disclosure. The method is applicable to a CPU. As shown in FIG. 4, the method includes steps 401 to 403.

At step 401, a message header of a to-be-processed message provided by a programmable device communicatively coupled to the CPU is acquired.

At step 402, the message header is processed to obtain a target message header.

At step 403, the target message header is provided to the programmable device, so that the programmable device splices the target message header with a payload portion of the to-be-processed message to obtain a target message, and forwards the target message.

In this example, implementation forms of the programmable device and the CPU can be seen in the relevant contents of the above embodiments, and will not be repeated here.

In this example, in order to take into account the flexibility and high performance of message processing, embodiments of the present disclosure provide a message processing manner combining software and hardware, that is, a network hardware offload scheme. A specific implementation process is as follows:

The programmable device may acquire the to-be-processed message in step 301. The to-be-processed message may be a message sent by a computer device to other physical machines, or may be a message sent by other physical machines and received by a computer device where the programmable device is located.

The programmable device then provides the message header of the to-be-processed message to the CPU in step 302. In some embodiments, the programmable device may provide the message header of the to-be-processed message to the CPU when the flow table for processing the to-be-processed message does not exist locally. In this example, local refers to a storage unit of the programmable device.

The CPU may receive the message header provided by the programmable device in step 401. In step 402, the message header may be processed to obtain the target message header. In some embodiments, a VS may run in the CPU. The VS running in the CPU processes the message header to obtain the target message header. Further, in step 403, the target message header may be provided to the programmable device.

Correspondingly, the programmable device may receive the target message header and splice, in step 303, the target message header with the payload portion of the to-be-processed message to obtain the target message. Further, in step 304, the programmable device may forward the target message to the target node referred to in the target message header.

If the to-be-processed message is a message sent, to other physical machines, by a host where the programmable device is located, the programmable device may send the target message to a network interface and forward the target message to other physical machines through the network interface. In this implementation, the target node is another physical machine.

If the to-be-processed message is a message sent by other physical machines and received by the host where the programmable device is located, that is, if the to-be-processed message is a message sent by other physical machines to the host where the programmable device is located and received by the network interface, the programmable device may send the target message to a VM running in the host.

In this example, the programmable device can provide the message header of the to-be-processed message for the CPU for processing, and splice the message header processed by the CPU with the payload portion of the to-be-processed message to obtain the target message, so that the payload portion of the message is processed using high performance of hardware of the programmable device, and the message header can be processed using flexibility of software in the CPU to process a complicated transaction logic. Since the message header is relatively short, for example, 256 bytes, performance loss in CPU software processing due to long-message copy processing does not occur, thus facilitating improvement of network forwarding performance.

On the other hand, the CPU processes the message header. Since software has a relatively short development cycle, it helps to meet a requirement for message forwarding flexibility and can meet the rapid iteration requirement of the cloud network.

In this example of the present disclosure, the CPU may also generate, after or during the processing of the header of the to-be-processed message, a flow table for processing the header of the to-be-processed message. Further, the CPU may provide the flow table for processing the message header of the to-be-processed message for the programmable device.

Correspondingly, the programmable device may receive the flow table for processing the message header of the to-be-processed message and store the flow table locally. In this way, the programmable device subsequently processes, on the basis of the flow table, other messages matching the data stream identifier of the to-be-processed message. In some embodiments, when receiving other messages belonging to the same data stream as the to-be-processed message, the programmable device may directly process other messages according to a processing manner recorded in a flow entry of the flow table, thereby realizing hardware offload of message forwarding, and improving the network forwarding performance.

A message belonging to the same data stream as the to-be-processed message refers to a message with the same data stream identifier as that of the to-be-processed message. the data stream identifier may be five-tuple information of the message header. Five-tuple includes: a source IP address, a source port, a destination IP address, a destination port and a transport layer protocol.

Based on this, in some embodiments, determining whether a flow table for processing the to-be-processed message exists locally includes: acquiring a data stream identifier in the message header of the to-be-processed message; matching the data stream identifier with locally stored flow tables; if the data stream identifier in the message header of the to-be-processed message does not exist in the locally stored flow tables, determining that the flow table for processing the to-be-processed message does not exist locally; if the locally stored flow tables include a flow table that matches the data stream identifier in the message header of the to-be-processed message, taking the matching flow table as a target flow table; and processing the to-be-processed message according to a processing manner recorded by a flow entry of the target flow table, so as to obtain a target message. Further, the programmable device may forward the to-be-processed message to a target node referred to in the target message header.

In some embodiments, the programmable device also stores a filter condition at which the complete message needs to be provided to the CPU for processing. The filter condition may include at least one of: a data stream identifier of the message that needs to be completely provided to the CPU, one or more of the five tuples, a destination network address and a source network address.

Correspondingly, when the flow table for processing the to-be-processed message does not exist locally, the programmable device may determine, on the basis of the data stream identifier in the message header of the to-be-processed message and the filter condition, whether to provide the complete to-be-processed message to the CPU. In some embodiments, if the filter condition include a destination network address and a source network address, the programmable device may parse the message header of the to-be-processed message to obtain the destination IP address and source IP address; acquire the destination network address and source network address of the to-be-processed message from the destination IP address and source IP address; match the destination network address and source network address of the to-be-processed message with the destination network address and source network address in the filter conditions; and if matching succeeds, determine that the complete to-be-processed message needs to be provided to the CPU. Further, the programmable device may provide the complete to-be-processed message to the CPU for processing.

Correspondingly, if a determination result is that the complete to-be-processed message does not need to be provided to the CPU, the programmable device may provide the message header of the to-be-processed message to the CPU, and the CPU processes the message header of the to-be-processed message.

In some embodiments, the programmable device may also be configured to acquire transaction information of the to-be-processed message; determine a processing manner of the to-be-processed message according to the transaction information of the to-be-processed message; and if the processing manner of the to-be-processed message is implemented by a CPU and a programmable device, provide the message header of the to-be-processed message for the CPU.

In some embodiments, the programmable device may acquire a transaction type of the to-be-processed message from the transaction information of the to-be-processed message; determine a target service grade corresponding to the transaction type of the to-be-processed message; acquire a message processing manner corresponding to the target service grade as the processing manner of the to-be-processed message; and/or acquire a transaction user identifier from the transaction information of the to-be-processed message; and acquire a message processing manner corresponding to the transaction user identifier as the processing manner of the to-be-processed message.

It should be noted that all executive agents of the various steps of the method provided by the above embodiments may be the same device, or the method is implemented by different devices. For example, an executive agent of step 401 and step 402 may be device A. For another example, an executive agent of step 401 may be device A, and an executive agent of step 402 may be device B.

In addition, some processes described in the above embodiments and accompanying drawings include a plurality of operations appearing in a specific order. However, it should be clearly understood that these operations may be executed or executed in parallel not in accordance with the order herein. The sequence numbers of the operations, such as 401 and 402, are only used to distinguish the various different operations. The sequence numbers themselves do not represent any order of execution. In addition, these processes may include more or fewer operations that may be executed in order or in parallel.

Correspondingly, some embodiments of the present disclosure further provide a computer-readable storage medium that stores computer instructions which, when executed by one or more processors, cause the one or more processors to perform the steps in the above message processing method.

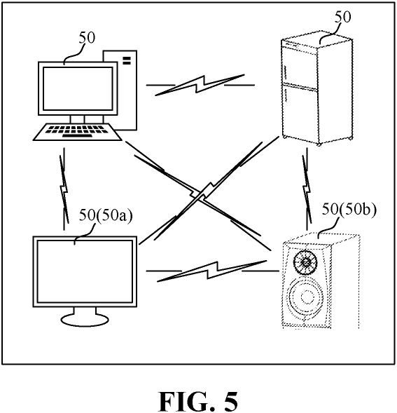

FIG. 5 is a schematic structural diagram of an example data processing system provided by an embodiment of the present application. As shown in FIG. 5, the data processing system includes: multiple physical devices 50 deployed in a specified physical space. Multiple sets refer to two or more sets. Multiple physical devices 50 are communicatively coupled.

Multiple physical devices 50 can be connected to each other wirelessly or wirelessly. In some embodiments, multiple physical devices 50 can be communicatively coupled to each other through mobile network communication. Correspondingly, a network type of a mobile network can be any one of 2G (GSM), 2.5G (GPRS), 3G (WCDMA, TD-SCDMA, CDMA2000, UTMS), 4G (LTE), 4G+ (LTE+), 5G, WiMax, and the like. In some embodiments, multiple physical devices 50 can also be communicatively coupled to each other by Bluetooth, WiFi, infrared, and other ways.

In this example, different application scenarios may lead to different implementation forms of physical devices. In the same physical scenario, physical devices can have various implementation forms. For example, in a home scenario, physical devices 50 can be, but are not limited to, at least two of a smart lock, a refrigerator, a television, a computer and a smart speaker.

In this example, first physical device 50a may acquire to-be-processed data and provide at least part (defined as data A) of the to-be-processed data to other physical devices 50b. The first physical device 50a is any physical device among the multiple physical devices. Other physical devices refer to other physical devices among the multiple physical devices 50 other than the first physical device 50a. Other physical devices 50b can be one or more, which is specifically determined by processing efficiency on the to-be-processed data and a volume of the to-be-processed data.

Correspondingly, second physical device 50b that receives data A provided by first physical device 50a can process data A to obtain a data processing result; and provide the data processing result to first physical device 50a. In this example, a specific processing manner for data A by second physical device 50b is not limited. In some embodiments, the processing manner for data A by second physical device 50b can be determined by, but is not limited to, a specific transaction requirement and/or an implementation form of data A.

For example, in some application scenarios, data A is image data. Second physical device 50b may perform image processing or image recognition on data A to determine image information. For another example, data A is audio data. Second physical device 50b can perform voice recognition on data A. For still another example, second physical device 50b can also encrypt data A and so on, but is not limited to this.

Further, second physical device 50b may provide a data processing result for first physical device 50a. First physical device 50a can determine a working mode according to the data processing result; and work according to the working mode.

The following is an exemplary description in combination with a specific embodiment. It is assumed that first physical device 50a is a television, and second physical device 50b is a smart speaker. A user can send a voice instruction to the television through voice interaction to control a working mode of the television, such as changing channels, adjusting the volume, and powering on and off. The television can acquire the voice instruction and provide the voice instruction to the smart speaker with a voice recognition function. The smart speaker performs voice recognition on the voice instruction to determine a need reflected by the voice instruction. Further, the smart speaker instructs the television to work in a working mode that meets the need reflected by the voice instruction. For example, the smart speaker can provide the need reflected by the voice instruction to the television. The television can acquire the need reflected by the voice instruction and work in the working mode that meets the need. For example, if the need reflected by the voice instruction is turning the volume up, the television can turn the volume up, or the like.

In some embodiments, computations supported by the multiple physical devices can be set. The computations supported by the multiple physical devices can be completed with cooperation of the multiple physical devices. For computations that are not supported by the multiple physical devices, the computations can be completed by cloud services corresponding to the multiple physical devices. If the computations are completed with the cooperation of the multiple physical devices locally, it is not necessary to transmit the to-be-processed data in a public network, which helps to improve data security and lower a leakage risk.

The embodiments may further be described using the following clauses:

1. A message processing system, comprising: a central processing unit (CPU) and a programmable device, wherein the programmable device is communicatively coupled to the CPU;
the programmable device is configured to provide a message header of an acquired to-be-processed message to the CPU;
the CPU is configured to process the message header to obtain a target message header, and provide the target message header to the programmable device; and
the programmable device is further configured to splice the target message header with a payload portion of the to-be-processed message to obtain a target message, and forward the target message to a target node referred to in the target message header.

2. The system according to clause 1, wherein the CPU is further configured to: generate a flow table for processing the message header, and provide the flow table for processing the message header to the programmable device; and

the programmable device is configured to locally store the flow table for processing the message header.

3. The system according to clause 1, wherein the programmable device is further configured to:
acquire a data stream identifier in the message header;
match the data stream identifier with locally stored flow tables, and if the data stream identifier does not exist in the locally stored flow tables, determine that no flow table for processing the to-be-processed message exists locally; and
when providing the message header to the CPU, the programmable device is configured to: provide the message header to the CPU in response to the flow table for processing the to-be-processed message does not exist locally.

4. The system according to clause 3, wherein the programmable device is further configured to:
if the locally stored flow tables comprise a flow table that matches the data stream identifier, take the matching flow table as a target flow table; and
process the to-be-processed message according to a processing manner recorded in a flow entry of the target flow table to obtain the target message.

5. The system according to clause 3, wherein the programmable device is configured to store a filter condition under which a complete message needs to be provided to the CPU; the programmable device is further configured to:
determine, on the basis of the data stream identifier and the filter condition, whether to provide the complete to-be-processed message to the CPU; and
if it is determined not to provide the complete to-be-processed message to the CPU, provide the message header of the to-be-processed message to the CPU.

6. The system according to clause 5, wherein the filter condition comprises: at least one of one or more of data stream identifiers of a message that needs to be completely provided to the CPU, a destination network address, and a source network address.

7. The system according to clause 6, wherein the filter condition comprises a destination network address and a source network address; and when determining whether to provide the complete to-be-processed message to the CPU, the programmable device is further configured to:
parse the message header of the to-be-processed message to obtain a destination IP address and a source IP address;
acquire a destination network address and a source network address of the to-be-processed message from the destination IP address and the source IP address;
match the destination network address and the source network address of the to-be-processed message with the destination network address and the source network address in the filter condition; and
if the destination network address and the source network address of the to-be-processed message matches the destination network address and the source network address respectively in the filter condition, provide the complete to-be-processed message to the CPU for processing.

8. The system according to clause 3, wherein the data stream identifier is five-tuple information in the message header.

9. The system according to any one of clauses 1-8, wherein the programmable device is a Field-Programmable Gate Array (FPGA), a Complex Programmable Logic Device (CPLD) or an Application Specific Integrated Circuit (ASIC).

10. The system according to any one of clauses 1-8, wherein the CPU is integrated on a system on chip or a microcontroller unit.

11. The system according to any one of clauses 1-8, wherein the CPU and the programmable device are deployed on the same network device; or, the CPU and the programmable device are deployed on different network devices.

12. The system according to clause 11, wherein the CPU and the programmable device are deployed in a network interface card, a gateway, or a router.

13. The system according to clause 12, wherein when the CPU and the programmable device are deployed in the network interface card, the network interface card further comprises a network interface and a bus interface; the network interface card is mounted on a host through the bus interface; and the network interface is configured to receive messages sent by other physical machines to the host, and forward a message sent by the host.

14. A message processing method, applicable to a programmable device and comprising:
acquiring a to-be-processed message;
providing a message header of the to-be-processed message for a central processing unit (CPU) communicatively coupled to the programmable device, wherein the CPU is configured to process the message header to obtain a target message header and return the target message header to the programmable device;
splicing the target message header with a payload portion of the to-be-processed message to obtain a target message; and
forwarding the target message to a target node referred to in the target message header.

15. The method according to clause 14, further comprising:
acquiring a flow table of the CPU for processing the message header; and
locally storing the flow table.

16. The method according to clause 14, wherein the providing the message header of the to-be-processed message to the CPU communicatively coupled to the programmable device further comprises:

providing the message header to the CPU when the flow table for processing the to-be-processed message does not exist locally.

17. The method according to clause 16, further comprising:
acquiring a data stream identifier in the message header;
matching the data stream identifier with locally stored flow tables; and
if the data stream identifier does not exist in the locally stored flow tables, determining that no flow table for processing the to-be-processed message exists locally.

18. The method according to clause 17, further comprising:
if the locally stored flow tables comprise a flow table that matches the data stream identifier, taking the matching flow table as a target flow table; and
processing the to-be-processed message according to a processing manner recorded in a flow entry of the target flow table to obtain the target message.

19. The method according to clause 17, wherein the programmable device is configured to store a filter condition under which a complete message needs to be provided to the CPU; and the method further comprises:
determining, on the basis of the data stream identifier and the filter condition, whether to provide the complete to-be-processed message to the CPU; and
if it is determined not to provide the complete to-be-processed message to the CPU, providing the message header of the to-be-processed message to the CPU.

20. The method according to clause 19, wherein the filter condition comprises: at least one of one or more of data stream identifiers of a message that needs to be completely provided to the CPU, a destination network address, and a source network address.

21. The method according to clause 20, wherein the filter condition comprises a destination network address and a source network address; and the determining whether to provide the complete to-be-processed message to the CPU further comprises:
parsing the message header of the to-be-processed message to obtain a destination IP address and a source IP address;
acquiring a destination network address and a source network address of the to-be-processed message from the destination IP address and the source IP address;
matching the destination network address and the source network address of the to-be-processed message with the destination network address and the source network address in the filter condition; and
if the destination network address and the source network address of the to-be-processed message matches the destination network address and the source network address respectively in the filter condition, providing the complete to-be-processed message to the CPU for processing.

22. The method according to clause 14, further comprising:
acquiring transaction information of the to-be-processed message;
determining, according to the transaction information of the to-be-processed message, a processing manner of the to-be-processed message; and
if the processing manner of the to-be-processed message is jointly processing the message by the CPU and the programmable device, providing the message header to the CPU.

23. The method according to clause 22, wherein the determining, according to the transaction information of the to-be-processed message, the processing manner of the to-be-processed message further comprises:
acquiring a transaction type of the to-be-processed message from the transaction information of the to-be-processed message; determining a target service grade corresponding to the transaction type of the to-be-processed message; and acquiring a message processing manner corresponding to the target service grade as the processing manner of the to-be-processed message; and/or,
acquiring a transaction user identifier from the transaction information of the to-be-processed message; and acquiring a message processing manner corresponding to the transaction user identifier as the processing manner of the to-be-processed message.

24. A message processing method, applicable to a central processing unit (CPU) and comprising:
acquiring a message header of a to-be-processed message provided by a programmable device communicatively coupled to the CPU;
processing the message header to obtain a target message header; and
providing the target message header to the programmable device, wherein the programmable device is configured to splice the target message header with a payload portion of the to-be-processed message to obtain a target message and forward the target message.

25. The method according to clause 24, further comprising:
generating a flow table for processing the message header; and
providing, to the programmable device, the flow table for processing the message header, wherein the programmable device is configured to process, on the basis of the flow table for processing the message header, other messages matching the data stream identifier of the to-be-processed message.

26. A data processing system, comprising a plurality of physical devices deployed in a specified physical space, wherein the plurality of physical devices are communicatively coupled;
a first physical device is configured to acquire to-be-processed data, and provide at least part of the data in the to-be-processed data to other physical devices;
the other physical devices are configured to process the at least part of the data to obtain a data processing result, and provide the data processing result to the first physical device; and
the first physical device is configured to determine a working mode according to the data processing result.

27. The system according to clause 26, wherein the plurality of physical devices comprise at least two of a smart lock, a refrigerator, a television, a computer, and a smart speaker.

28. A network device, comprising a programmable device, wherein the programmable device is communicatively coupled to a central processing unit (CPU); and the programmable device is configured to perform the method according to any one of claims 14 to 23.

29. The device according to clause 28, wherein the CPU is deployed in the network device.

30. The device according to clause 28 or 29, wherein the network device is a network interface card, a router, or a gateway.

31. A network device, comprising a memory and a central processing unit (CPU), wherein the memory is configured to store a computer program; the CPU is communicatively coupled to the programmable device; and

the CPU is coupled to the memory, and is configured to execute the computer program to perform the method according to clause 24 or 25.

32. A computer-readable storage medium for storing computer instructions which, when executed by one or more processors, cause the one or more processors to perform the method according to any one of clauses 14 to 25.

In some embodiments, a non-transitory computer-readable storage medium including instructions is also provided, and the instructions may be executed by a device, for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A message processing system, comprising:
a central processing unit (CPU) and a programmable device, wherein the programmable device is communicatively coupled to the CPU;
the programmable device is configured to provide a message header of an acquired to-be-processed message to the CPU;
the CPU is configured to:
process the message header to obtain a target message header; and
provide the target message header to the programmable device; and
the programmable device is further configured to
splice the target message header with a payload portion of the to-be-processed message to obtain a target message; and
forward the target message to a target node referred to in the target message header.

2. The system according to claim 1, wherein the CPU is further configured to:
generate a flow table for processing the message header; and
provide the flow table for processing the message header to the programmable device; and
the programmable device is further configured to locally store the flow table for processing the message header.

3. The system according to claim 1, wherein the programmable device is further configured to:
acquire a data stream identifier in the message header;
match the data stream identifier with locally stored flow tables, and if the data stream identifier does not exist in the locally stored flow tables, determine that no flow table for processing the to-be-processed message exists locally; and
when providing the message header to the CPU, the programmable device is further configured to:
provide the message header to the CPU in response to the flow table for processing the to-be-processed message does not exist locally.

4. The system according to claim 3, wherein the programmable device is further configured to:
if the locally stored flow tables comprise a flow table that matches the data stream identifier, take the matching flow table as a target flow table; and
process the to-be-processed message according to a processing manner recorded in a flow entry of the target flow table to obtain the target message.

5. The system according to claim 3, wherein the programmable device is configured to store a filter condition under which a complete message needs to be provided to the CPU; the programmable device is further configured to:
determine, on the basis of the data stream identifier and the filter condition, whether to provide the complete to-be-processed message to the CPU; and
if it is determined not to provide the complete to-be-processed message to the CPU, provide the message header of the to-be-processed message to the CPU.

6. The system according to claim 5, wherein the filter condition comprises: at least one of one or more of data stream identifiers of a message that needs to be completely provided to the CPU, a destination network address, and a source network address.

7. The system according to claim 6, wherein the filter condition comprises a destination network address and a source network address; and when determining whether to provide the complete to-be-processed message to the CPU, the programmable device is further configured to:
parse the message header of the to-be-processed message to obtain a destination IP address and a source IP address;
acquire a destination network address and a source network address of the to-be-processed message from the destination IP address and the source IP address;
match the destination network address and the source network address of the to-be-processed message with the destination network address and the source network address in the filter condition; and
if the destination network address and the source network address of the to-be-processed message matches the destination network address and the source network address respectively in the filter condition, provide the complete to-be-processed message to the CPU for processing.

8. The system according to claim 1, wherein the CPU and the programmable device are deployed on the same network device; or
the CPU and the programmable device are deployed on different network devices.

9. The system according to claim 8, wherein the CPU and the programmable device are deployed in a network interface card, a gateway, or a router.

10. A message processing method, applicable to a programmable device and comprising:
acquiring a to-be-processed message;
providing a message header of the to-be-processed message to a central processing unit (CPU) communicatively coupled to the programmable device, wherein the CPU is configured to process the message header to obtain a target message header and return the target message header to the programmable device;
splicing the target message header with a payload portion of the to-be-processed message to obtain a target message; and
forwarding the target message to a target node referred to in the target message header.

11. The method according to claim 10, further comprising:
acquiring a flow table of the CPU for processing the message header; and
locally storing the flow table.

12. The method according to claim 10, wherein the providing the message header of the to-be-processed message to the CPU communicatively coupled to the programmable device further comprises:
providing the message header to the CPU when the flow table for processing the to-be-processed message does not exist locally.

13. The method according to claim 12, further comprising:
acquiring a data stream identifier in the message header;
matching the data stream identifier with locally stored flow tables; and
if the data stream identifier does not exist in the locally stored flow tables, determining that no flow table for processing the to-be-processed message exists locally.

14. The method according to claim 13, further comprising:
if the locally stored flow tables comprise a flow table that matches the data stream identifier, taking the matching flow table as a target flow table; and
processing the to-be-processed message according to a processing manner recorded in a flow entry of the target flow table to obtain the target message.

15. The method according to claim 13, wherein the programmable device is configured to store a filter condition under which a complete message needs to be provided to the CPU; and the method further comprises:
determining, on the basis of the data stream identifier and the filter condition, whether to provide the complete to-be-processed message to the CPU; and
if it is determined not to provide the complete to-be-processed message for the CPU, providing the message header of the to-be-processed message to the CPU.

16. The method according to claim 15, wherein the filter condition comprises: at least one of one or more of data stream identifiers of a message that needs to be completely provided to the CPU, a destination network address, and a source network address.

17. The method according to claim 16, wherein the filter condition comprises a destination network address and a source network address; and the determining whether to provide the complete to-be-processed message to the CPU further comprises:
parsing the message header of the to-be-processed message to obtain a destination IP address and a source IP address;
acquiring a destination network address and a source network address of the to-be-processed message from the destination IP address and the source IP address;
matching the destination network address and the source network address of the to-be-processed message with the destination network address and the source network address in the filter condition; and
if the destination network address and the source network address of the to-be-processed message matches the destination network address and the source network address respectively in the filter condition, providing the complete to-be-processed message to the CPU for processing.

18. The method according to claim 10, further comprising:
acquiring transaction information of the to-be-processed message;
determining, according to the transaction information of the to-be-processed message, a processing manner of the to-be-processed message; and
if the processing manner of the to-be-processed message is jointly processing the message by the CPU and the programmable device, providing the message header to the CPU.

19. The method according to claim 18, wherein the determining, according to the transaction information of the to-be-processed message, the processing manner of the to-be-processed message further comprises:
acquiring a transaction type of the to-be-processed message from the transaction information of the to-be-processed message;
determining a target service grade corresponding to the transaction type of the to-be-processed message; and
acquiring a message processing manner corresponding to the target service grade as the processing manner of the to-be-processed message; and/or
acquiring a transaction user identifier from the transaction information of the to-be-processed message; and
acquiring a message processing manner corresponding to the transaction user identifier as the processing manner of the to-be-processed message.

20. A message processing method, applicable to a central processing unit (CPU) and comprising:
acquiring a message header of a to-be-processed message provided by a programmable device communicatively coupled to the CPU;
processing the message header to obtain a target message header; and
providing the target message header to the programmable device, wherein the programmable device is configured to splice the target message header with a payload portion of the to-be-processed message to obtain a target message and forward the target message.

21. The method according to claim 20, further comprising:
generating a flow table for processing the message header; and
providing, to the programmable device, the flow table for processing the message header, wherein the programmable device is configured to process, on the basis of the flow table for processing the message header, other messages matching the data stream identifier of the to-be-processed message.
